(19) United States
(12) Patent Application Publication
(10) Pub. No.: US 2015/0096413 A1
(43) Pub. Date: Apr. 9, 2015

(54) Quick Release Ratchet Driver

(71) Applicants: Colin G. Knight, Winnetka, IL (US); Milos Coric, Lincolnshire, IL (US); David Luczynski, Elgin, IL (US); Elvin Bautista, Streamwood, IL (US)

(72) Inventors: Colin G. Knight, Winnetka, IL (US); Milos Coric, Lincolnshire, IL (US); David Luczynski, Elgin, IL (US); Elvin Bautista, Streamwood, IL (US)

(21) Appl. No.: 14/048,903

(22) Filed: Oct. 8, 2013

(51) Int. Cl. B25B 21/00

(52) U.S. Cl. CPC B25B 21/004
USPC 81/57.13

(57) ABSTRACT

A ratchet having an internal motor for rotatably displacing a mechanical fastener. The motor has a torque capacity that provides a minimum torque level. The minimum torque level is below a maximum torque level that is used to secure, or loosen, the mechanical fastener at/from a tightened position. When the mechanical fastener is being moved toward the desired tightened position, the motor of the ratchet may allow for relatively rapid rotational displacement of the mechanical fastener until the torque capacity of the motor is reached. The remaining torque, or maximum torque level, then needed to secure the mechanical fastener in, or at, a tightened position may be provided by the user pushing or pulling on the handle of the ratchet, wherein a wheel in the head portion having a drive may thereby be rotated so that a mechanical fastener that is operably connected to the drive is also rotated.

### BACKGROUND OF THE INVENTION

Ratchet tools are typically hand tools used to tighten or loosen a mechanical fastener. For example, a ratchet tool may include, or be operably connected to, a socket that is sized to engage a mechanical fastener, such as a nut or bolt, among others. Often, ratchet tools are configured for the mechanical fastener to be tightened or loosened with a reciprocating motion of the ratchet tool without requiring the ratchet tool to be removed from engagement with the mechanical fastener.

When the ratchet tool is engaged with a mechanical fastener, a handle of the ratchet tool may be manually pushed or pulled by a user to tighten or loosen the engagement of the mechanical fastener with a work piece or apparatus. Moreover, when the mechanical fastener is to be tightened or loosened with respect to a mating threaded connector or work piece, the handle of the ratchet tool may be rotated in a first direction by the user from a first position toward a second position. Such rotation in the first direction may at least partially turn the mechanical fastener in a desired direction so as to tighten or loosen the mechanical fastener. Often the second position is at a location in which space considerations prevent the further rotational movement of the handle in the first direction and/or the handle has reached a less advantageous and/or relatively uncomfortable position for the user. Further, typically, the second position is at a location that is less than one complete revolution from the first position. The user may then manually push or push the handle in a second direction that is opposite to the rotational direction of the first direction, so that the handle moves back towards the first position, without rotating the mechanical fastener. The user may continuously, and repeatedly, push and pull on the ratchet tool handle in the first and second directions while tightening, loosening, or removing the mechanical fastener to/from the work piece.

However, in at least certain situations, the manual maneuvering of the ratchet tool may be relatively time consuming and tiresome. For example, in certain situations, the mechanical fastener may need to traverse along a relatively long mating threaded connector. In such situations, the number of times the handle is needed to be repeatedly, and manually, rotated between first and second positions may be relatively significant, thereby requiring relatively significant time and user energy before the mechanical fastener is tightened and/or removed from the work piece.

### BRIEF SUMMARY OF THE INVENTION

Certain embodiments of the present technology provide a ratchet for rotatably displacing a mechanical fastener. The ratchet includes a body having a head portion and a handle. The head portion is configured to house a wheel that has a drive. The ratchet further includes a motor that is housed within the body. The motor is configured to provide power to rotate the wheel.

Additionally, certain embodiments of the present technology provide a ratchet for rotatably displacing a mechanical fastener, the ratchet including a body having a head portion and a handle. The head portion is configured to house a wheel having a drive. The ratchet also includes a motor that is housed within the body and which is configured to provide power to rotate the wheel. Additionally, the motor has a torque capacity that provides a minimum torque level for rotatably displacing the mechanical fastener, the minimum torque level being below a maximum torque level, the maximum torque level being a torque level used to secure the mechanical fastener at a tightened position. The ratchet also includes a switch that is operably connected to the motor. The switch has a first position and a second position. The first position is configured for the motor to provide power to rotate the wheel in a first direction, while the second position is configured for the motor to provide power to rotate the wheel in a second direction. Further, the second direction is in a direction that is opposite of the first direction.

Embodiments of the present technology also provide a ratchet for rotatably displacing a mechanical fastener that includes a body having a handle and a head portion, the head portion configured to house a worm drive. The worm drive includes a screw and a wheel having a drive. The ratchet also includes a motor that is housed within the body. The motor is configured to provide power to rotate the worm drive in a first direction and a second direction, the second direction being in a direction that is opposite of the first direction. Additionally, the motor has a torque capacity that provides a minimum torque level for rotatably displacing the mechanical fastener, the minimum torque level being below a maximum torque level, the maximum torque level being a torque level used to secure the mechanical fastener at a tightened position.

### BRIEF DESCRIPTION OF SEVERAL VIEWS OF THE DRAWINGS

FIG. 1 is a perspective view of a ratchet tool according to an illustrated embodiment.

FIG. 2 is a perspective view of a portion of the ratchet tool illustrated in FIG. 1.

FIG. 3 is a perspective view cross sectional view of a portion of the head portion of the ratchet tool illustrated in Figure.

FIG. 4 is a perspective cross sectional view of a ratchet tool according to an illustrated embodiment with a cap removed from the handle.

FIG. 5 is an exploded view of a ratchet tool attached to a socket, a mechanical fastener, and work piece having an internal thread.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

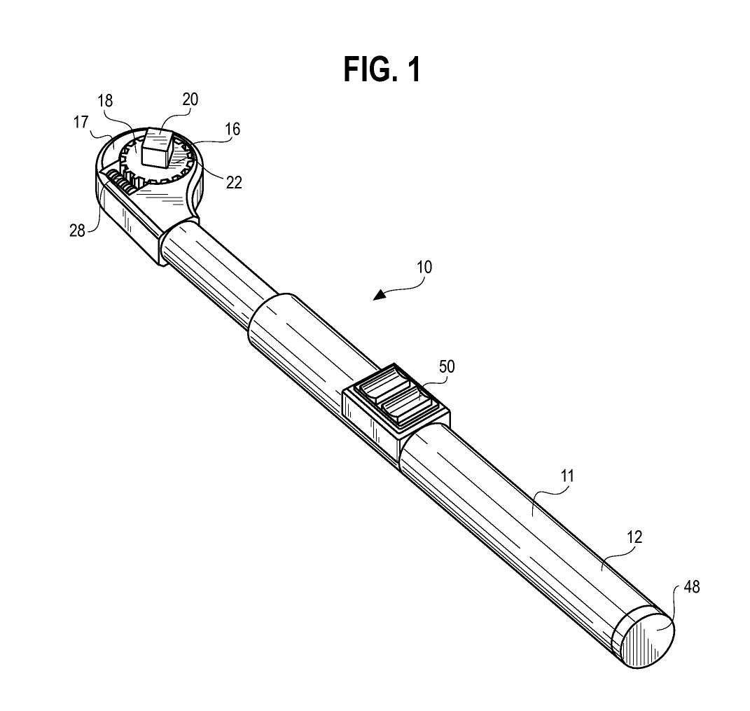

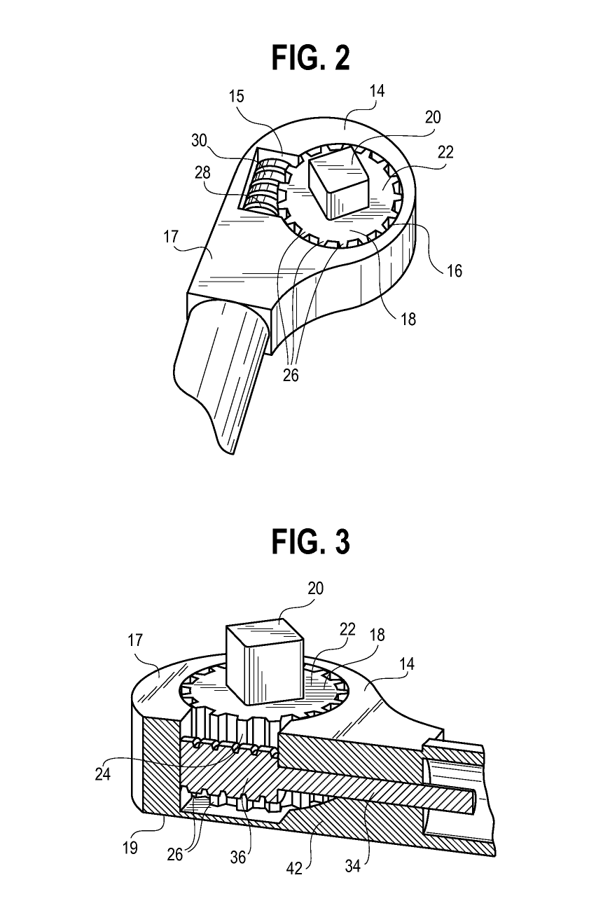

FIGS. 1-4 illustrate a ratchet tool 10 according to an illustrated embodiment. The ratchet tool 10 includes body 11 having a handle 12 a head portion 14. The head portion 14 includes an orifice 16 that is sized to house at least a portion of a wheel 18. Further, according to certain embodiments, at least one end of the orifice 16 may be sized to receive the insertion of the wheel 18 into the orifice 16, and thus into the head portion 14 of the ratchet tool 10. The wheel 18 may be retained in the orifice 16 in a variety of different manners, including, for example, through the use of one or more retaining clips, clamps, or brackets, among other fasteners.

The wheel 18 may be configured for a direct or indirect connection to a mechanism used to engage a mechanical fastener, such as, for example, a nut, bolt, or screw, among others. For example, according to certain embodiments, the wheel 18 may include a drive 20 that extends away from a first side 22 of the wheel 18. The driver 20 may be configured to be received in an aperture of a socket. For example, the drive 20 may be a ¼ inch, ⅜ inch, or ½ inch square drive, among other sizes, that is configured to be received in a mating aperture of a socket. The drive 20 may engage a variety of different types of sockets, such as, for example, sockets that are configured for engagement with mechanical fasteners that have or include a hex head, Allen head, star head, Torx head, and/or square head configuration, among others.

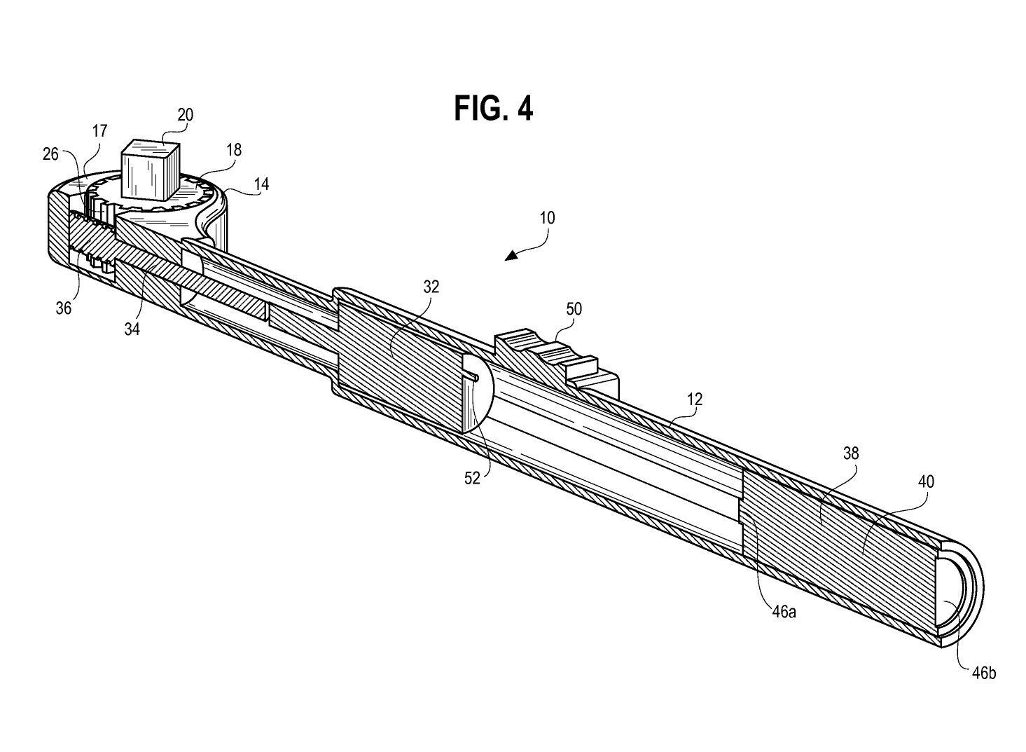

At least a portion of an outer face portion 24 of the wheel 18 includes a plurality of serrations 26. For example, in the embodiment illustrated in FIGS. 1 and 4, the wheel 18 is a worm wheel such that the serrations 26 may be worm gear teeth that may or may not be throated. Such worm gear teeth may be configured to mate an external thread(s) 30 of a screw 28 that may, at least partially, also be positioned in head portion 14 of the ratchet tool 10. According to such embodiments, the screw 28 may be a single or multi-threaded worm. In such worm drive embodiments, the wheel 28 may be rotated about an axis that is generally perpendicular to the axis of rotation of the screw 28. Further, during the rotation of the screw 20, the rotation of the associated thread(s) 30 may sequentially engage one or more adjacent serrations 26 in a manner that results in the rotation of the wheel 18 in the orifice 16.

As discussed below, the serrations 26 of the wheel 18 and thread(s) 30 of the screw 28 may be configured such that the screw 28 may rotate the wheel 18 in a first direction and a second, opposite, direction. For example, the lead angle, pressure angle, and/or the coefficient of friction of the worm drive and/or thread(s) 30 and serrations 26 may be configured to allow for the wheel 18 to be turned, by the rotation of the screw 28, in both a first direction and a second direction that is opposite of the first direction.

The wheel 18 and the screw 28 may be constructed from a variety of different materials, including metal, nylon, and plastic, among others. According to certain embodiments, the wheel 18 and/or screw 28 may be constructed from heat treated steel. Alternatively, at portion of the wheel 18 and/or screw 28 may undergo heat treating, such as, for example, flame treating the serrations 18 to harden at least an outer surface of the serrations 18.

According to certain embodiments, the screw 28 is directly or indirectly connected to a motor 32 that is used to drive the rotation of the screw 28. According to certain embodiments, the screw 28 may include, or be operably connected or coupled to, a drive shaft 34. For example, the drive shaft 34 may extend away from a body portion 36 of the screw 28. Alternatively, the drive shaft 34 may be operably connected to the screw 28, such as through the use of a set screw, pin, key, or coupling, among other connections. Similarly, the drive shaft 34 may also be operably connected or coupled to the motor 32, or may be part of the motor 32, such as being at least a portion of the shaft of the motor 32.

The motor 32 may be positioned in an inner portion 42 of the head portion 14 and/or an interior section 44 of the handle 12. Thus, according to certain embodiments, the drive shave 34 may extend along at least a portion of the inner portion 42 of the head portion 14 and/or the interior section 44 of the handle 12. Further, as shown in FIGS. 1-4, according to certain embodiments, at least a portion of the thread 30 portion of the screw 28 may be placed in, and visible through, an opening 15 in the head portion 14. According to certain embodiments, the opening 15 may extend through a first side 17 and/or a second side 19 of the head portion 14. Further, the opening 15 may be in communication with the inner portion 42 of the head portion 14.

A variety of different types of motors 32 may be employed to provide power to rotate the screw 28, and thereby provide power to rotate the wheel 18. For example, according to the illustrated embodiment, the motor 32 may be an electrical motor, such as, for example, a brushless direct current (DC) motor or permanent magnet motor, among other rotating motors. Additionally, a power source 38 may be used to supply the motor 32 with power. For example, according to certain embodiments, the power source 38 may be at least one battery 40, such as a rechargeable lithium battery, among others, that has positive and negative electrodes, poles, or terminals 46a, 46b. The power source 38 may also be positioned in an inner portion 42 of the head portion 14 and/or the interior section 44 of the handle 12.

Further, the ratchet tool 10 may include a cap 48 to accommodate access to the power source 38. For example, according to certain embodiments, the cap 48 may positioned at an end of the handle 12 opposite of the location of the head portion 12. The cap 48 may be configured to be displaced or removed from a closed position to an open position, and vice versa, so as to provide access to the power source 38 and to at least assist in retaining the power source in the ratchet tool 10. Such access may allow for the removal, insertion, and/or replacement of the power source 38 from the ratchet tool 10. For example, referencing FIG. 1, the cap 38 may be displaced or removed from the handle 12, such that the cap 48 is in an open position. With the cap 48 in the open position, the power source 38 may be removed from, or inserted into, the ratchet tool 10, such as being inserted into the inner section 44 of the handle 12. The cap 48 may then be returned to a closed position, such as, for example, via an internal thread of the cap 38 mating an external thread of the handle 12, so as to secure the power source in or on the ratchet tool 10.

The power source 38 is operably connected to a switch 50. For example, according to certain embodiments, the electrodes 46a, 46b of the battery 40 may be operably connected to a switch 50, such as, for example, via wires and/or contact strips 56a, 56b. According to certain embodiments, the negative terminal 46b of the battery 40 may be directly or indirectly in contact with a contact strip that is directly connected to the switch 50 and/or which is connected to the switch 50 by one or more wires. Similarly, the positive terminal 46a of the battery 40 may also be directly or indirectly in contact with a contact strip that is directly connected to the switch 50 and/or which is connected to the switch 50 by one or more wires. Further, according to certain embodiments, the contact strip may include, or be operably connected to, a spring that is in contact with the battery 40, and through which electrons may flow.

The switch 50 may operably connected to the motor 32, such as via a wire(s) to one or more terminals 52 of the motor 32. Moreover, the switch 50 may be configured to control the delivery of the power, such as electricity, to the motor 32, and thus control the activation of the motor 32. Further, according to certain embodiments, the switch 50 is a motor direction reversing switch, such as, for example, a rocker switch, among others, such that the switch 50 may be used in adjusting the direction the motor rotates. For example, according to certain embodiments, when the switch 50 is in a first position, the motor 32 may rotate in a first direction, such as, for example, in a clockwise direction. However, when the switch 50 is in the second position, the motor 32 may rotate in a second direction that is opposite of the first direction, such as, for example, in a counter-clockwise direction. The switch 50 may also include a third position in which the switch 50 prevents the closing of a circuit so that power is not delivered to the motor 32 and thus the motor 32 is neither rotating in a first or second direction.

As previously discussed, when activated, the motor 32 may rotate the drive shaft 34, which is translated into rotational movement of the screw 28 and associated rotation of the wheel 18 and drive 20. Thus, power provided by the motor 32 may be translated into powered rotational movement of the wheel 18 (and drive 20). Further, the screw 28 and wheel 18 are configured such that the direction of the powered rotation of the wheel 18 and drive 20 may be based on the direction of the rotation of the motor 32. Thus, the wheel 18 and drive 20 may be powered to rotate in a direction when the motor 32 is rotating in the first direction that is opposite to the direction that the wheel 18 and drive 20 are powered to rotate when the motor 32 is rotating in the second direction.

According to certain embodiments, the motor 32 may be relatively compact in size such that the motor 32 may fit within the interior section 44 of the handle 12. Further, the handle 12 may have a size that allows, the hand, or a portion of the hand, of an average size user, to wrap around the entire handle 12. For example, according to certain embodiments, the handle 12 may be approximately 20 millimeter or ¾ inch in width. Such a compact motor 32 may provide sufficient power for relatively rapid rotational movement of the drive 20 when the ratchet tool 10 is being used to provide at least an initial amount of torque.

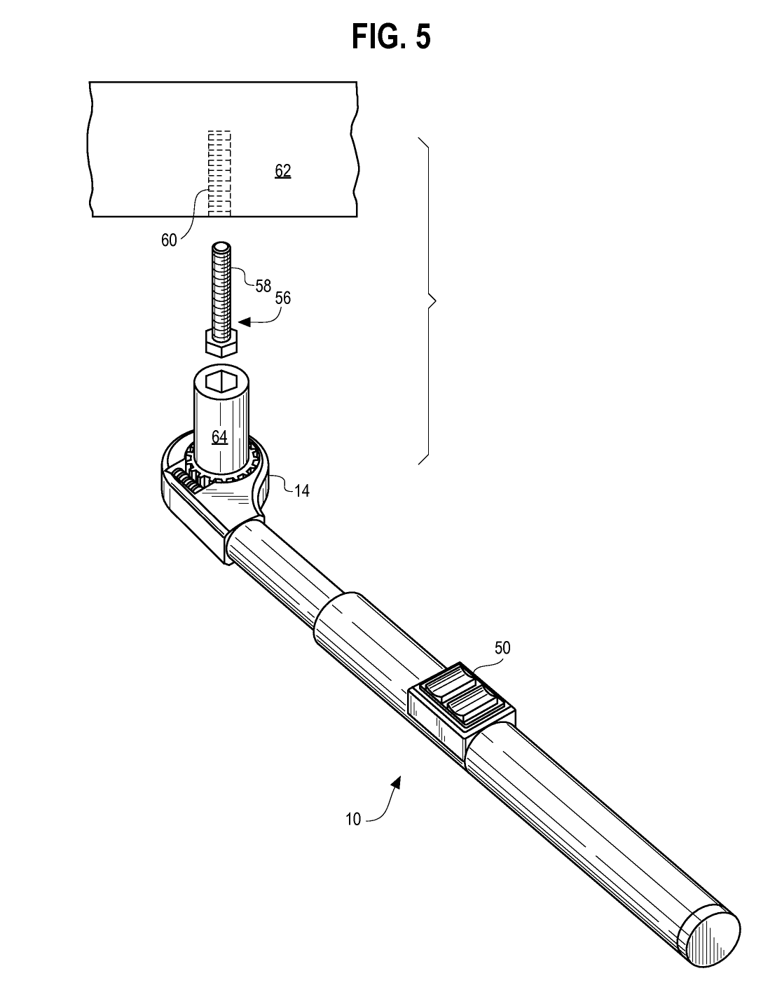

For example, referencing FIG. 5, in certain situations, a mechanical fastener 56, such as a hex head bolt, may include a relatively long external thread portion 58 that engages a mating internal thread 60 in a work piece 62 when the fastener 56 is being secured or tightened to the work piece 62. In such situations, the mechanical fastener 56 may need to be rotated numerous times using a minor torque before the mechanical fastener 56 begins to be tightened to the work piece 62. The minor torque provided may vary depending upon the tool 10. For example, for certain tools 10, the minor torque may be around 25 inch-pounds. In such situations, the compact motor 32 may provide power that is translated to sufficient torque and relatively rapid rotation of the drive 20, which is used to relatively rapidly displace the mechanical fastener 56 toward the tightened position. Moreover, such powered, rapid rotation of the drive 20 by the motor 32, and the associated rotation of the mechanical fastener 56, may exceed the speed at which a user many manually rotate the mechanical fastener 56 using a traditional ratchet tool. Further, such powered rotation of the drive 20 and the mechanical fastener 56 may not require the repetitious user wrist and/or arm pulling or pushing movement associated with traditional ratchets.

As the mechanical fastener 56 begins to reach the tightened position, the torque needed to continue to rotate the mechanical fastener 56 may be elevated from the minor toque level to a major torque level. In certain situations, the major torque level may exceed the maximum torque capacity of the motor 32. For example, in certain applications, the major torque necessary to tighten a mechanical fastener 56 may be approximately 250 inch-pounds, which may exceed the torque capacity of the motor 32. In such situations the motor 32 may provide the force necessary to rotate the fastener 56 until the torque capacity of the motor 32 is reached, such as, for example, a motor torque capacity of 50 inch-pounds. In such a situation, the remaining torque needed to attain the 250 inch-pounds of torque may be manually provided by the user. Thus, according to certain embodiments, when the torque capacity of the motor 32 is exceeded, and the motor 32 is unable to continue rotating the mechanical fastener 56 the user may elect to deactivate the motor 32, such as, for example, by moving the switch 50 from the first position to a third position. The remaining torque, or major torque level, if needed or desired to further tighten the mechanical fastener 56, may then be provided by the user pushing or pulling the handle 12 in appropriate direction so as rotate the drive 20 with sufficient torque to complete the tightening the mechanical fastener 56 to the work piece 62.

Similarly, in certain situations in which the torque needed to at least initially loosen a mechanical fastener 56 from the work piece 62 exceeds the maximum torque provided by the motor 32, the user may initially push or pull the handle 12 in appropriate direction so as rotate the drive 20 with sufficient torque to initially loosen or break the mechanical fastener 56 away from the tightened position. With the mechanical fastener 56 loosen or broken from the tightened position, the level of torque necessary to rotate the mechanical fastener 56 away from the tightened position may decrease to a torque level below the maximum torque capacity of the motor 32, such as to a minor torque level. Accordingly, the motor 32 may then, if not already, be activated, such as, for example, by the user displacing the switch 50 from the third position to a second position. The motor 32 may then provide power to rotate the wheel 18 and drive 20, and thus rotate the associated socket 64 and mechanical fastener 56, so as to relatively rapidly displace the mechanical fastener 56 further away from the tightened position and/or remove the mechanical fastener 56 from engagement with the work piece 62.

Additionally, even in situations in which the torque needed to rotate the mechanical fastener 56 exceeds the torque capacity of the motor 32, the motor 32 may be used to rotate the drive 20 so as to utilize and/or remove backlash between the screw 28 and wheel 18 to adjust the positioning of the handle 12 relative to the user and/or work piece. For example, when the ratchet 10 and associated socket 64 are engaged with a mechanical fastener 56, the backlash may be used, through operation of the motor 32, to adjust the position of the handle 12 by five degrees. Such adjustments may be used to improve the positioning or user access to the handle 12 so as to improve the ease and/or comfort at which the user may push or pull on the handle 12 when the ratchet tool 10 is being used to tighten/loosen a mechanical fastener 56. Similarly, embodiments of the present invention may allow for the removal of backlash by operation of the motor 32, thereby allowing the ratchet 10 to be used as a generally zero degree backlash ratchet when elasticity and/or deformation in the wheel 18 and/or screw 23 is at a minimum. However, once the torque required to rotate the mechanical fastener 56 is within a range that may be provided by operation of the motor 32, such as below the maximum torque capacity of the motor 32, and the fastener 56 is operably engaged with ratchet 10 through the socket 64, the handle 12 may be maintained in a relatively stationary position as the powered rotation of the drive 20 is translated into rotational movement of the mechanical fastener 56.

While the apparatus has been described with reference to preferred embodiments, it will be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the appended claims.

1. A ratchet for rotatably displacing a mechanical fastener comprising:
a body having a head portion and a handle, the head portion configured to house a wheel, the wheel having a drive; and
a motor housed within the body, the motor configured to provide power to rotate the wheel.

2. The ratchet of claim 1 further including a screw having at least one thread, the at least one thread configured to engage one or more serrations of the wheel, the screw being operably connected to the motor.

3. The ratchet of claim 2 further including a switch that is operably connected to the motor, the switch having a first position and a second position, the first position configured for the motor to rotate the screw in a first direction, the second position configured for the motor to rotate the screw in a second direction, the second direction being in a direction that is opposite of the first direction.

4. The ratchet of claim 3, wherein at least a portion of the motor is housed within an interior section of the handle.

5. The ratchet of claim 1, wherein the motor has a torque capacity that provides a minimum torque level for rotatably displacing the mechanical fastener, the minimum torque level being below a maximum torque level, the maximum torque level being a torque level used to secure the mechanical fastener at a tightened position.

6. The ratchet of claim 5, wherein the ratchet includes a power source, the power source configured to be housed within the body.

7. The ratchet of claim 6, wherein the power source is housed in an interior section of the handle.

8. The ratchet of claim 7, wherein the power source is a lithium battery.

9. The ratchet of claim 5, wherein the motor is operably connected to the screw by a drive shaft.

10. The ratchet of claim 5, wherein the motor is configured to adjust the position of the screw relative to the wheel to allow for adjustment of a location of the handle when a torque level needed to rotate the mechanical fastener is greater than the minimum torque level.

11. A ratchet for rotatably displacing a mechanical fastener comprising:
a body having a head portion and a handle, the head portion configured to house a wheel, the wheel having a drive;
a motor housed within the body, the motor configured to provide power to rotate the wheel, the motor having a torque capacity that provides a minimum torque level for rotatably displacing the mechanical fastener, the minimum torque level being below a maximum torque level, the maximum torque level being a torque level used to secure the mechanical fastener at a tightened position; and
a switch that is operably connected to the motor, the switch having a first position and a second position, the first position configured for the motor to provide power to rotate the wheel in a first direction, the second position configured for the motor to provide power to rotate the wheel in a second direction, the second direction being in a direction that is opposite of the first direction.

12. The ratchet of claim 11 further including a screw having at least one thread, the at least one thread configured to mate one or more serrations of the wheel, the screw being operably connected to the motor.

13. The ratchet of claim 12, wherein at least a portion of the motor is housed within an interior section of the handle.

14. The ratchet of claim 12, wherein at least a portion of the motor is housed within an inner portion of the head portion.

15. The ratchet of claim 12, wherein the ratchet includes a power source, the power source configured to be housed within the body.

16. The ratchet of claim 15, wherein the power source is housed in an interior section of the handle.

17. The ratchet of claim 11, wherein the motor is configured to adjust the position of the screw relative to the wheel to allow for adjustment of a location of the handle when the torque level needed to rotate the mechanical fastener is greater than the minimum torque level.

18. A ratchet for rotatably displacing a mechanical fastener comprising:
a body having a head portion and a handle, the head portion configured to house a worm drive, the worm drive including a screw and a wheel, the wheel having a drive;
a motor housed within the body, the motor configured to provide power to rotate the worm drive in a first direction and a second direction, the second direction being in a direction that is opposite of the first direction, the motor having a torque capacity that provides a minimum torque level for rotatably displacing the mechanical fastener, the minimum torque level being below a maximum torque level, the maximum torque level being a torque level used to secure the mechanical fastener at a tightened position.

19. The ratchet of claim 18 further including a switch configured for the selection of rotation of the worm drive in the first and second directions.

20. The ratchet of claim 19, wherein the motor is configured to adjust the position of the screw relative to the wheel to allow for adjustment of a location of the handle when a torque level needed for the rotation of the mechanical fastener is greater than the minimum torque level.
